(19) United States
(12) Patent Application Publication
(10) Pub. No.: US 2013/0120294 A1
(43) Pub. Date: May 16, 2013

(54) APPARATUS WITH TOUCH SCREEN FOR PRELOADING MULTIPLE APPLICATIONS AND METHOD OF CONTROLLING THE SAME

(71) Applicant: SAMSUNG ELECTRONICS CO. LTD., Suwon-si (KR)

(72) Inventors: Kwang-Won SUN, Suwon-si (KR); Kang-Tae KIM, Yongin-si (KR); Duck-Hyun KIM, Suwon-si (KR); Eun-Young KIM, Yongin-si (KR); Chul-Joo KIM, Suwon-si (KR)

(73) Assignee: SAMSUNG ELECTRONICS CO. LTD., Suwon-si (KR)

(21) Appl. No.: 13/678,992

(22) Filed: Nov. 16, 2012

(30) Foreign Application Priority Data
Nov. 16, 2011 (KR) 10-2011-0119882

(51) Int. Cl. G06F 3/041

(52) U.S. Cl. CPC G06F 3/041
USPC 345/173

(57) ABSTRACT

An apparatus for a touch screen is provided. The apparatus includes a touch screen having a first window in which a first application is run and a second window in which a second application is run, a storage element for storing a plurality of applications including the first and second applications, and preset information about an arrangement order in which the plurality of applications are placed, and a controller for controlling the touch screen to display the first and second applications in the first and second windows, respectively, and determining a predetermined number of applications, with respect to the first and second applications, for preloading in an active region of the storage element from among the plurality of applications based on the preset information about the arrangement.

### PRIORITY

This application claims the benefit under 35 U.S.C. §119(a) of a Korean patent application filed on Nov. 16, 2011 in the Korean Intellectual Property Office and assigned Serial No. 10-2011-0119882, the entire disclosure of which is hereby incorporated by reference.

### BACKGROUND OF THE INVENTION

1. Field of the Invention

The present invention relates to an apparatus with a touch screen for preloading a plurality of applications and a method of controlling the same. More particularly, the present invention relates to an apparatus with a touch screen for displaying split-screens and a method of preloading a plurality of applications.

2. Description of the Related Art

As demand for smart phones and tablets has surged, new studies have been conducted on interface methods related to the operation of the touch screen included in smart phones and tablets. In particular, research in to smart phones and tablets providing intuitional interface methods related to user experience have been conducted, and a resultant variety of papers regarding interface methods adapted to user intuition have been published.

Most smart phones and tablets have touch screens and thus recent research has been directed toward interface methods aimed at providing a user with an easier and more accurate method.

When running an application, conventional smart phones or tablets adopt a configuration of displaying a window in which to display an application on the entire touch screen. Thus, in a case of trying to run another application while running a first application, the smart phone or tablet has to stop displaying the first application and start displaying the other application. Thus, users may suffer from the inconvenience of having to input a manipulation signal to switch to a first menu screen and then having to input another manipulation signal to run the other application in the first menu screen.

Furthermore, in the case of multitasking many applications, the need of having to keep inputting manipulation signals to switch between applications occurs, and thus, users may not easily know the processing results for each application.

Therefore, when displaying multiple applications, there exists a need to develop a technique of splitting a single touch screen to display the respective applications.

Additionally, when such switching between applications is required, it takes a while for the conventional smart phone or tablet to initialize an application to run. In an environment in which applications often run and are switched from one to another, there may be many resources consumed for the application initialization, which may compromise Quality of Service (QoS).

Therefore, a need also exists for an apparatus and method to minimize the time and resource burden required to initialize multiple applications in smart phones and tablets, as well as a technique for improving resource consumption.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below.

Accordingly, an aspect of the present invention is to provide a solution to the foregoing problem by providing an apparatus having a touch screen, and method of controlling the apparatus by which application running or switching is quickly performed by preloading a plurality of applications.

In accordance with an aspect of the present invention, an apparatus with a touch screen is provided. The apparatus includes a touch screen having a first window in which a first application is run and a second window in which a second application is run, a storage element for storing a plurality of applications including the first and second applications, and preset information about an arrangement order in which the plurality of applications are placed, and a controller for controlling the touch screen to display the first and second applications in the first and second windows, respectively, and determining a predetermined number of applications, with respect to the first and second applications, for preloading in an active region of the storage element from among the plurality of applications based on the preset information about the arrangement.

In accordance with another aspect of the present invention, a method of controlling an apparatus with a touch screen having a first window in which a first application is run and a second window in which a second application is run is provided. The method includes displaying the first and second applications in the first and second windows, respectively, reading out preset information about an arrangement order in which a plurality of applications including the first and second applications are placed, and, based on the preset information about the arrangement order, and with respect to the first and second applications, determining a predetermined number of applications for preloading in an active region of the storage element from among the plurality of applications.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1A is a block diagram of an apparatus with a touch screen according to an exemplary embodiment of the present invention;

FIG. 1B is a schematic diagram of the apparatus according to an exemplary embodiment of the present invention;

FIG. 2 is a perspective view of a mobile device according to an exemplary embodiment of the present invention;

FIG. 3A is a conceptual diagram of an apparatus with a touch screen including first and second windows according to an exemplary embodiment of the present invention;

FIG. 3B is a conceptual diagram of an apparatus with a touch screen including first and second windows according to an exemplary embodiment of the present invention;

FIG. 3C is a conceptual diagram of an implementation according to an exemplary embodiment of the present invention;

FIGS. 3D to 3G are conceptual diagrams for explaining a change of a display screen by switching between running applications according to an exemplary embodiment of the present invention;

FIG. 3H is a conceptual diagram of an apparatus with a touch screen including first, second, and third windows according to an exemplary embodiment of the present invention;

FIG. 3I is a conceptual diagram of an apparatus with a touch screen including first and second windows according to an exemplary embodiment of the present invention;

FIG. 4 is a flowchart of a method of controlling an apparatus with a touch screen for preloading a plurality of applications according to an exemplary embodiment of the present invention;

FIGS. 5A and 5B are conceptual diagrams explaining receiving instructions to display first and second applications in the first and second windows, respectively according to an exemplary embodiment of the present invention;

FIG. 5C is a conceptual diagram explaining a procedure of determining an active region for preloading according to an exemplary embodiment of the present invention;

FIGS. 5D and 5E are conceptual diagrams explaining a preloading method by dividing a main thread according to an exemplary embodiment of the present invention;

FIG. 5F is a conceptual diagram explaining determining an active and non-active region according to an exemplary embodiment of the present invention;

FIG. 6 is a flowchart of a method of controlling an apparatus with a touch screen to preload a plurality of applications when switching between applications according to an exemplary embodiment of the present invention;

FIGS. 7A to 7E are conceptual diagrams explaining a change of an active region in switching between applications according to an exemplary embodiment of the present invention; and

FIG. 8 is a flowchart of a method of controlling an apparatus with a touch screen to preload a plurality of applications when switching between applications according to an exemplary embodiment of the present invention.

The same reference numerals are used to represent the same elements throughout the drawings.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and configurations may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term substantially it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

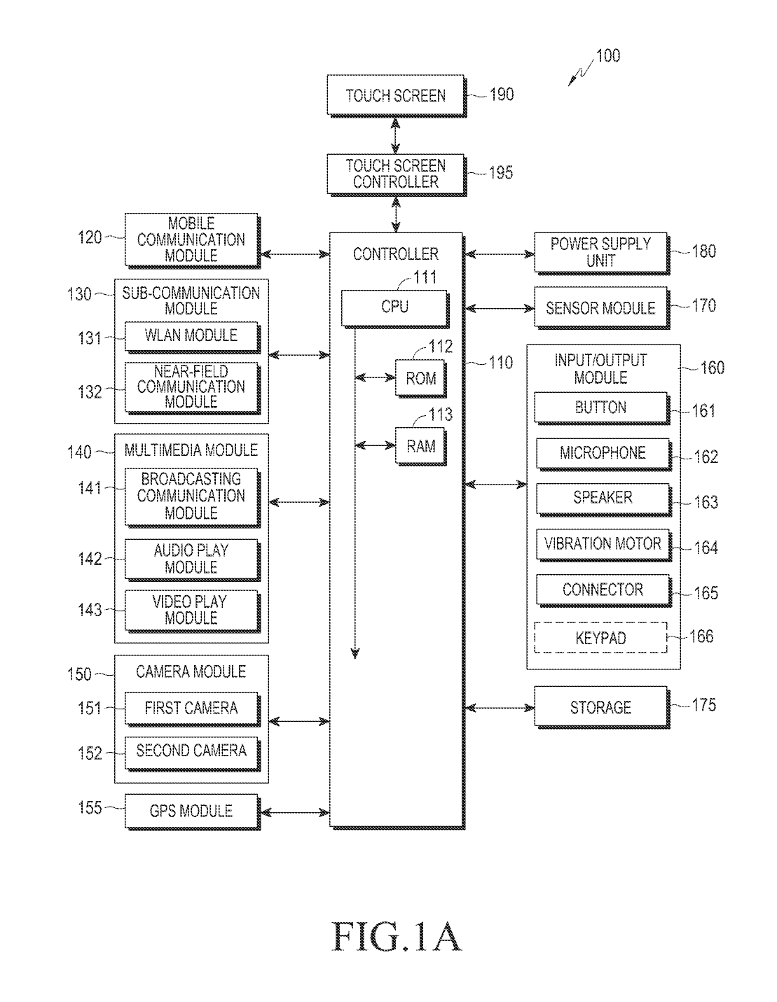

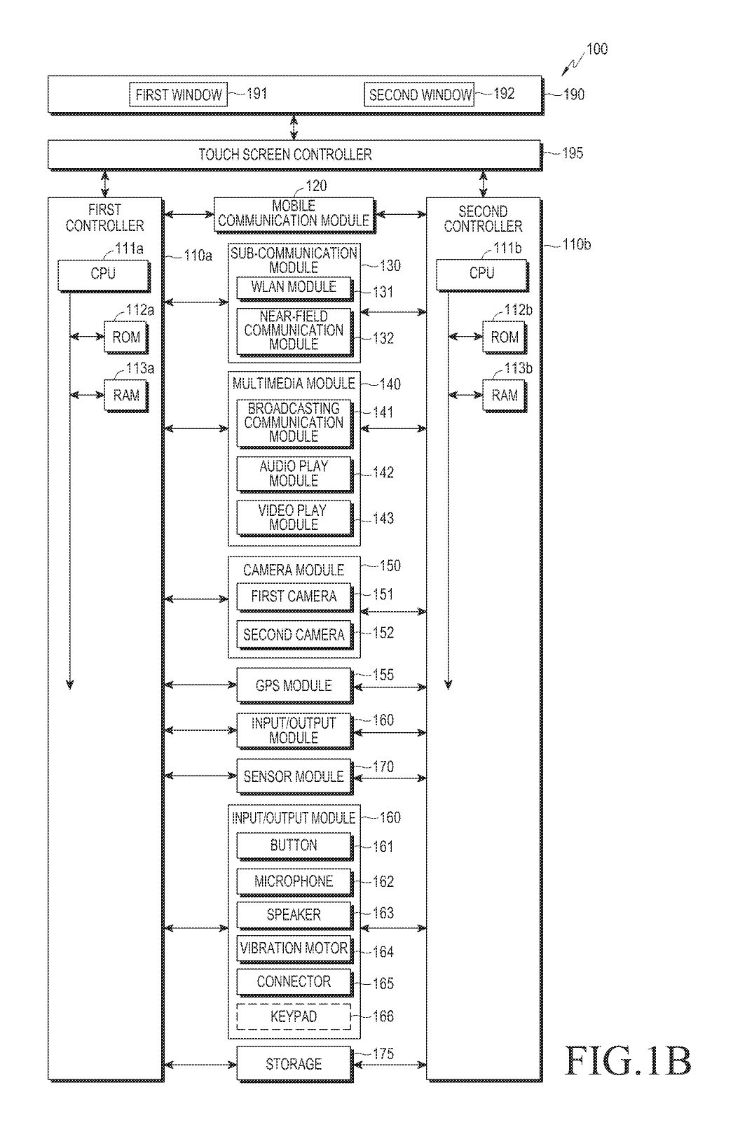

FIG. 1A is a block diagram of an apparatus with a touch screen according to an exemplary embodiment of the present invention.

Referring to FIG. 1A, an apparatus 100 with a touch screen 190 may be connected to an external device (not shown) via a mobile communication module 120, a sub-communication module 130, and a connector 165. The “external device” may include any of another device, a cell phone, a smart phone, a tablet Personal Computer (PC), a server, and the like, none of which are shown.

In FIG. 1A, the apparatus 100 includes a touch screen 190 and a touch screen controller 195. The apparatus 100 also includes a controller 110, the mobile communication module 120, the sub-communication module 130, a multimedia module 140, a camera module 150, a GPS module 155, an input/output module 160, a sensor module 170, a storage element 175, and a power supply 180. The sub-communication module 130 includes at least one of Wireless Local Area Network (WLAN) 131 and a near-field communication module 132. The multimedia module 140 includes at least one of a broadcast communication module 141, an audio play module 142, and a video play module 143. The camera module 150 includes at least one of a first camera 151 and a second camera 152. The input/output module 160 includes at least one of buttons 161, a microphone 162, a speaker 163, a vibration motor 164, a connector 165, and a keypad 166.

The controller 110 may include a Central Processing Unit (CPU) 111, a Read Only Memory (ROM) 112 for storing a control program to control the apparatus 100, and a Random Access Memory (RAM) 113 for storing signals or data input from an outside or for being used as a memory space for working results in the apparatus 100. The CPU 111 may include a single core, dual cores, triple cores, or quad cores. The CPU 111, ROM 112, and RAM 113 may be connected to each other via an internal bus.

The controller 110 may control the mobile communication module 120, the sub-communication module 130, the multimedia module 140, the camera module 150, the GPS module, the input/output module 160, the sensor module 170, the storage element 175, the power supply 180, the touch screen 190, and the touch screen controller 195.

The mobile communication module 120 uses at least one-one or more antennas (not shown) under control of the controller 110 to connect the apparatus 100 to an external device through mobile communication. The mobile communication module 120 transmits/receives wireless signals for voice calls, video conference calls, Short Message Service (SMS) messages, or Multimedia Message Service (MMS) messages to/from a cell phone (not shown), a smart phone (not shown), a tablet PC (not shown), or another device (not shown), the phones having phone numbers entered into the apparatus 100.

The sub-communication module 130 may include at least one of a WLAN module 131 and a near-field communication module 132. For example, the sub-communication module 130 may include either a WLAN module 131 or a near-field communication module 132, or both.

The WLAN module 131 may be connected to the Internet in a place where there is an Access Point (AP) (not shown) under control of a controller 110. The WLAN module 131 supports, for example, the Institute of Electrical and Electronics Engineers (IEEE's) WLAN standard IEEE802.11x. The near-field module 132 may conduct near-field communication between the apparatus 100 and an image rendering device (not shown) under control of a controller 110. The near-field module may include Bluetooth, Infrared Data Association (IrDA), or the like.

The apparatus 100 may include at least one of the mobile communication module 120, the WLAN module 131 and the near-field communication module 132 based on performance. For example, the apparatus 100 may include a combination of the mobile communication module 120, the WLAN module 131 and the near-field communication module 132 based on performance.

The multimedia module 140 may include the broadcast communication module 141, the audio play module 142, or the video play module 143. The broadcast communication module 141 may receive broadcast signals (e.g., television broadcast signals, radio broadcast signals, or data broadcast signals) and additional broadcast information (e.g., Electric Program Guide (EPG) or Electric Service Guide (ESG)) transmitted from a broadcasting station through a broadcast communication antenna (not shown) under control of the controller 110. The audio play module 142 may play digital audio files (e.g., files having extensions, such as mp3, wma, ogg, or way) stored or received under control of the controller 110. The video play module 143 may play digital video files (e.g., files having extensions, such as mpeg, mpg, mp4, avi, move, or mkv) stored or received under control of the controller 110. The video play module 143 may also play digital audio files.

The multimedia module 140 may include the audio play module 142 and the video play module 143 except for the broadcast communication module 141. The audio play module 142 or video play module 143 of the multimedia module 140 may be included in the controller 100.

The camera module 150 may include at least one of the first and second cameras 151 and 152 for capturing still images or video images under control of the controller 110. The camera module 150 may include ether the first camera 151 or a second camera 152, or both. Furthermore, the first or second camera 151 or 152 may include an auxiliary light source (e.g., a flash (not shown)) for providing as much an amount of light as required for capturing an object. In exemplary embodiments, the first and second camera 151 and 152 may be arranged adjacent to each other (e.g., the distance between the first and second camera 151 and 152 may be in a range from 1 to 8 cm) for capturing 3D still images or 3D video images. If, for example, a distance between the first and second cameras 151 and 152 is less than a length across a first housing 100a (e.g., perpendicular to a distance DO, the first and second camera 151 and 152 may be arranged in the front and back of the apparatus 100, respectively.

The GPS module 155 may receive radio signals from a plurality of GPS satellites (not shown) in Earth's orbit, and may calculate a position of the apparatus 100 by using a time of arrival of a signal from the GPS satellites to the apparatus 100.

The input/output module 160 may include at least one of the plurality of buttons 161, the microphone 162, the speaker 163, the vibration motor 164, the connector 165, and the keypad 166.

The microphone 162 generates electric signals by receiving voice or sound under control of a controller 110. There may be one or more microphones 162 arranged in exemplary embodiments.

The speaker 163 may output sounds corresponding to various signals (e.g., radio signals, broadcast signals, digital audio files, digital video files or photography signals) from the mobile communication module 120, sub-communication module 130, multimedia module 140, or camera module 150 to an outside under control of a controller 110. The speaker 163 may output sounds (e.g., button-press sounds or ringback tones) that correspond to functions performed by the apparatus 100.

The vibration motor 164 may convert an electric signal to a mechanical vibration under control of the controller 110. For example, the apparatus 100 in a vibration mode may operate the vibration motor 164 when receiving a voice call from another device (not shown).

In exemplary embodiments of the present invention, the vibration motor 164 of the apparatus 100 may operate in response to touching of the touch screen 190.

The connector 165 may be used as an interface for connecting the apparatus 100 to an external device (not shown) or a power source (not shown). Under control of the controller 110, data stored in the storage element 175 of the apparatus 100 may be transmitted to the external device via a cable connected to the connector 165, or data may be received from the external device. Power may be received from the power source via a cable connected to the connector 165 or a battery (not shown) may be charged.

The keypad 166 may receive key inputs from a user to control the apparatus 100. The keypad 166 includes a mechanical keypad (not shown) formed in the apparatus 100 or a virtual keypad (not shown) displayed on the touch screen 190. The mechanical keypad may be formed in the apparatus 100, or may be excluded depending on the performance or structure of the apparatus 100.

The sensor module 170 may include at least one sensor for detecting a status of the apparatus 100. For example, the sensor module 170 may include a proximity sensor for detecting proximity of a user to the apparatus 100, an illumination sensor for detecting an amount of ambient light, or a motion sensor (not shown) for detecting an operation of the apparatus 100 (e.g., rotation of the apparatus 100, acceleration or vibration imposed on the apparatus 100). At least one sensor may detect a status and generate a corresponding signal to transmit to the controller 110. The sensor of a sensor module 170 may be added or removed depending on the performance of the apparatus 100.

The storage element 175 may store signals or data input/output according to operations of the mobile communication module 120, the sub-communication module 130, the multimedia module 140, the camera module 150, the GPS module 155, the input/output module 160, the sensor module 170, or the touch screen 190 under control of the controller 110. The storage element 175 may store the control program for controlling the apparatus 100 or the controller 110.

The term “storage element” implies not only the storage element 175, but also the ROM 112, RAM 113 in the controller 110, or a memory card (not shown) (e.g., an SD card, a memory stick) installed in the apparatus 100. The storage element may also include a non-volatile memory, volatile memory, Hard Disc Drive (HDD), or Solid State Drive (SSD).

The power supply 180 may supply power to one or more batteries (not shown) under control of the controller 110. The one or more batteries may power the apparatus 100. The power supply 180 may supply the apparatus 100 with the power input from an external power source (not shown) via, for example, a cable connected to the connector 165.

The touch screen 190 may provide a user with a user interface for various services (e.g., call, data transmission, broadcasting, photography services). The touch screen 190 may send an analog signal corresponding to at least one touch input to the user interface to the touch screen controller 195. The touch screen 190 may receive the at least one touch from a user's physical contact (e.g., with fingers including thumb) or a via a touchable touch device (e.g., a stylus pen). The touch screen 190 may receive consecutive moves of one of the at least one touch. The touch screen 190 may send an analog signal corresponding to consecutive moves of the input touch to the touch screen controller 195.

Touches in the present invention are not limited to physical touches by a physical contact of the user or contacts with the touchable touch device, but may also include touchless (e.g., keeping a detectable distance less than 1 mm between the touch screen 190 and a user's body or touchable touch device). The detectable distance from the touch screen 190 may vary depending on, e.g., the performance or structure of the apparatus 100.

The touch screen 190 may be implemented using various technologies e.g., those including resistivity, capacitance, infrared sensors, or acoustics.

The touch screen controller 195, for example, converts an analog signal received from the touch screen 190 to a digital signal (e.g., XY coordinates) and transmits the digital signal to the controller 110. The controller 110 may control the touch screen 190 by using the digital signal received from the touch screen controller 195. For example, in response to the touch, the controller 110 may enable a shortcut icon (not shown) displayed on the touch screen 190 to be selected or to be executed. The touch screen controller 195 may also be incorporated in the controller 110.

FIG. 1B is a schematic diagram of an apparatus according to an exemplary embodiment of the present invention.

Referring to FIG. 1B, most components except for a first controller 110a, a second controller 110b, and the touch screen 190 are substantially the same, so redundant descriptions may be herein omitted.

The first controller 110a may include a CPU 111a, a ROM 112a for storing a control program to control the apparatus 100, and a RAM 113a for storing signals or data input from the outside, or as a memory space for working results in the apparatus 100. The first controller 110a may control the mobile communication module 120, the sub-communication module 130, the multimedia module 140, the camera module 150, the GPS module, the input/output module 160, the sensor module 170, the storage element 175, the power supply 180, a first window 191 of the touch screen 190, and the touch screen controller 195. Here, the first window 191 and the second window 192 refer to independent areas obtained by marking off and dividing the touch screen 190. The first and second windows 191 and 192 may be implemented, although not exclusively, in a form of simply marking off the entire touch screen 190, or may be independent areas contained in the entire touch screen 190. The first and second windows 191 and 192 may be independent, divided areas of the touch screen 190 from the user's perspective, and may be independent, divided sets of pixels contained in the touch screen 190, from a hardware perspective. Conceptual positional relationships between the first and second windows 191 and 192 will be described below in more detail.

The touch screen controller 195 can, for example, convert an analog signal received from the touch screen 190, especially, the touch screen area corresponding to the first window 191 to a digital signal (e.g., XY coordinates) and transmit the digital signal to the first controller 110a. The first controller 110a may control the first window 191 of the touch screen 190 by using the digital signal received from the touch screen controller 195. The touch screen controller 195 may also be incorporated in the first controller 110a.

The second controller 110b may include a CPU 111b, a ROM 112b for storing a control program to control the apparatus 100, and a RAM 113b for storing signals or data input from the outside, or as a memory space for working results in the apparatus 100.

The second controller 110b may control the mobile communication module 120, the sub-communication module 130, the multimedia module 140, the camera module 150, the GPS module 155, the input/output module 160, the sensor module 170, the storage element 175, the power supply 180, the touch screen 190, such as a second window 192 of the touch screen 190, and the touch screen controller 195.

The touch screen controller 195 can, for example, convert an analog signal received from the touch screen 190 area corresponding to the second window 192 to a digital signal (e.g., XY coordinates) and transmit the digital signal to the first controller 110a. The second controller 110b may control the touch screen 190, for example, the touch screen 190 area corresponding to the second window 192 of the touch screen 190 by using the digital signal received from the touch screen controller 195. The touch screen controller 195 may also be incorporated in the second controller 110b.

In an exemplary embodiment of the present invention, the first controller 110a may control at least one component (e.g., the touch screen 190, the touch screen controller 195, the mobile communication module 120, the sub-communication module 130, the multimedia module 140, the first camera 151, the GPS module 155, a first button group 161a, a power/lock button (not shown), at least one volume button (not shown), the sensor module 170, the storage element 175, and the power supply 180).

The second controller 110b may control at least one component (e.g., the touch screen 190, the touch screen controller 195, the second camera 152, a second button group 160b, the storage element 175 and the power supply 180).

In an exemplary embodiment of the present invention, the first controller 110a and the second controller 110b may control the components of the apparatus 100 by modules, i.e., the first controller 110a may control the mobile communication module 120, the sub-communication module 130, and the input/output module 160, and the second controller 110b may control the multimedia module 140, the camera module 150, the GPS module 155, and the sensor module 170. The first and second controllers 110a and 110b may control the components of the apparatus 100 according to priority, i.e., the first controller 110a may prioritize the mobile communication module 120, and the second controller 110b may prioritize the multimedia module 140. The first and second controllers 110a and 110b may be separately arranged. The first and second controllers 110a and 110b may also be implemented in a single controller having a CPU with a plurality of cores, such as dual or quad cores.

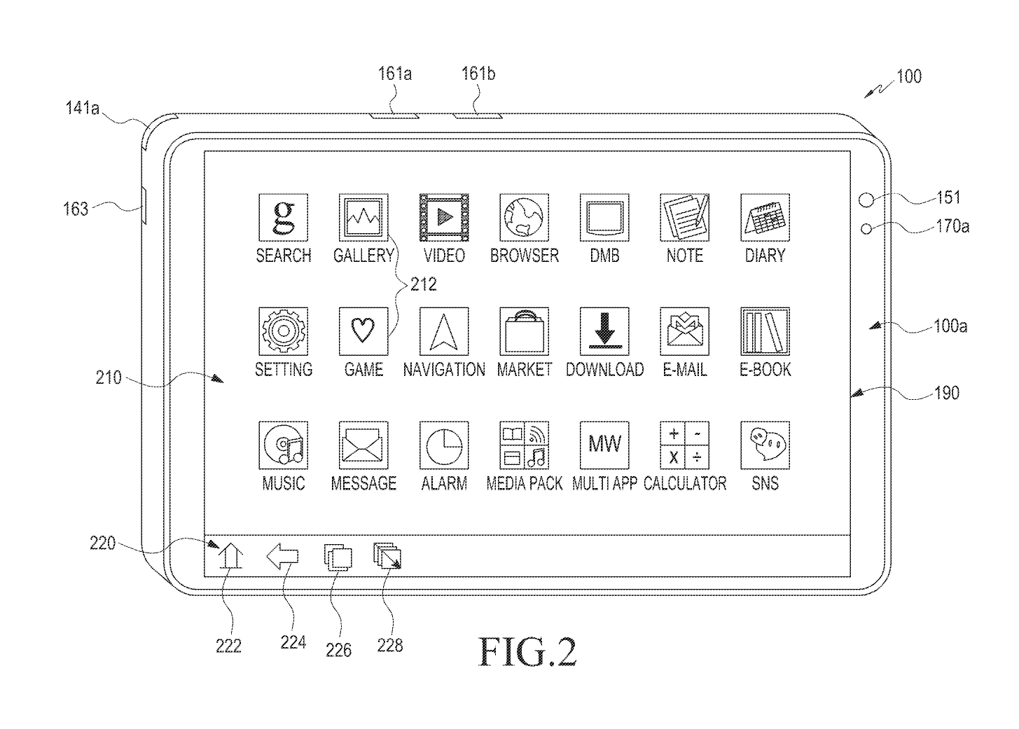

FIG. 2 is a perspective view of a mobile device according to an exemplary embodiment of the present invention.

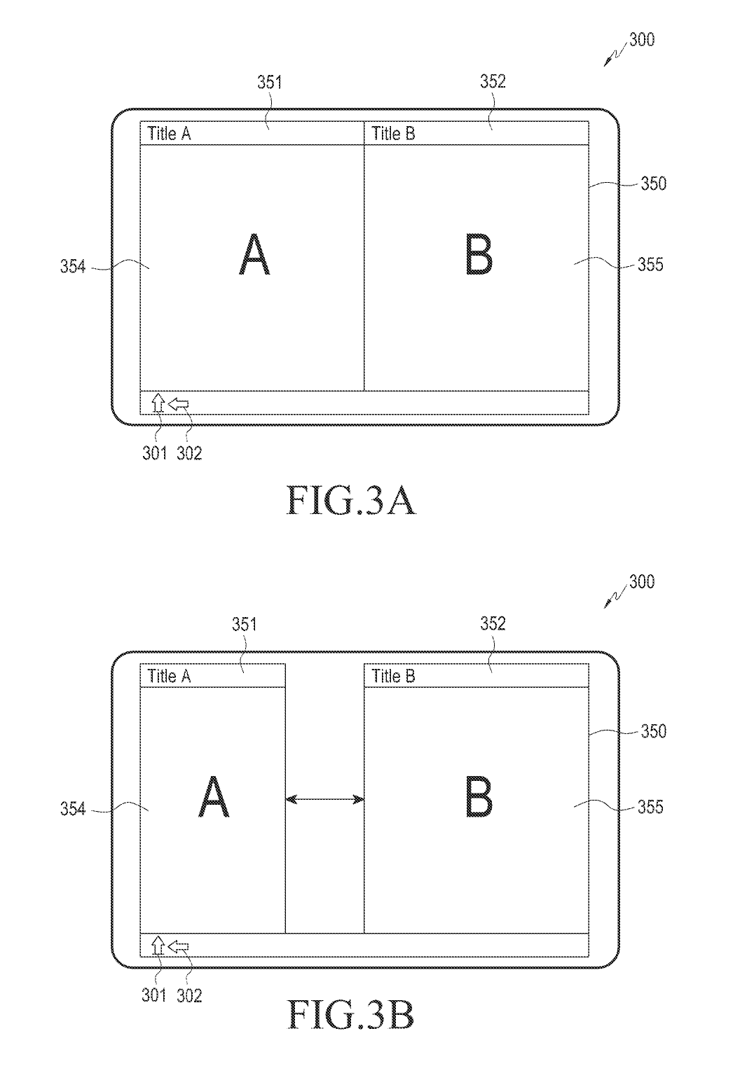

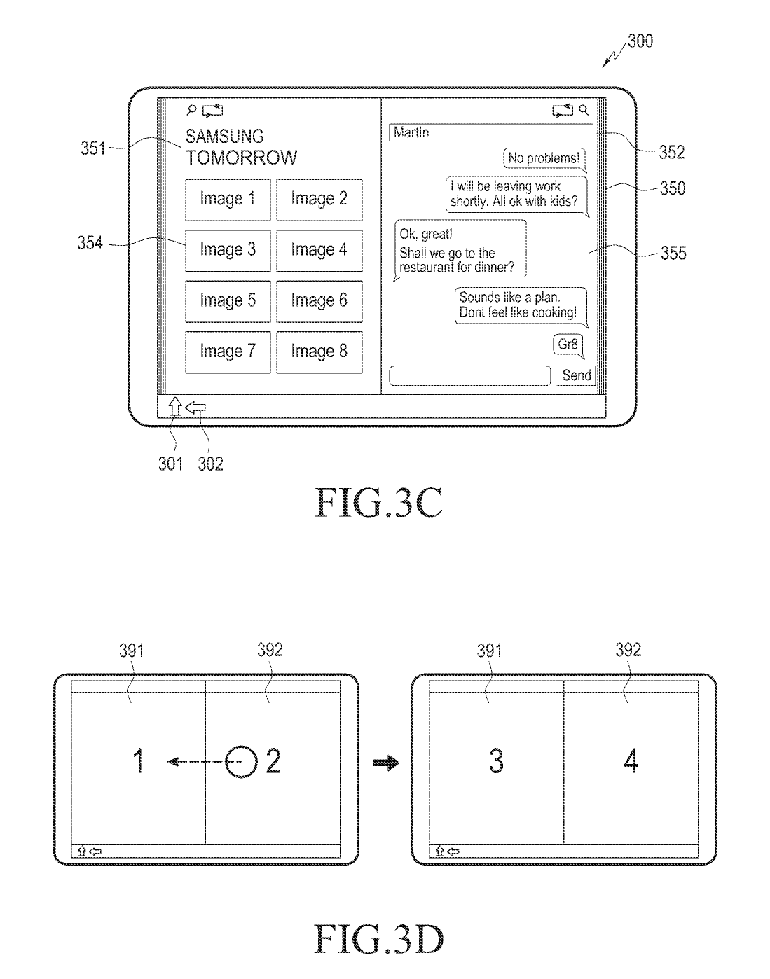

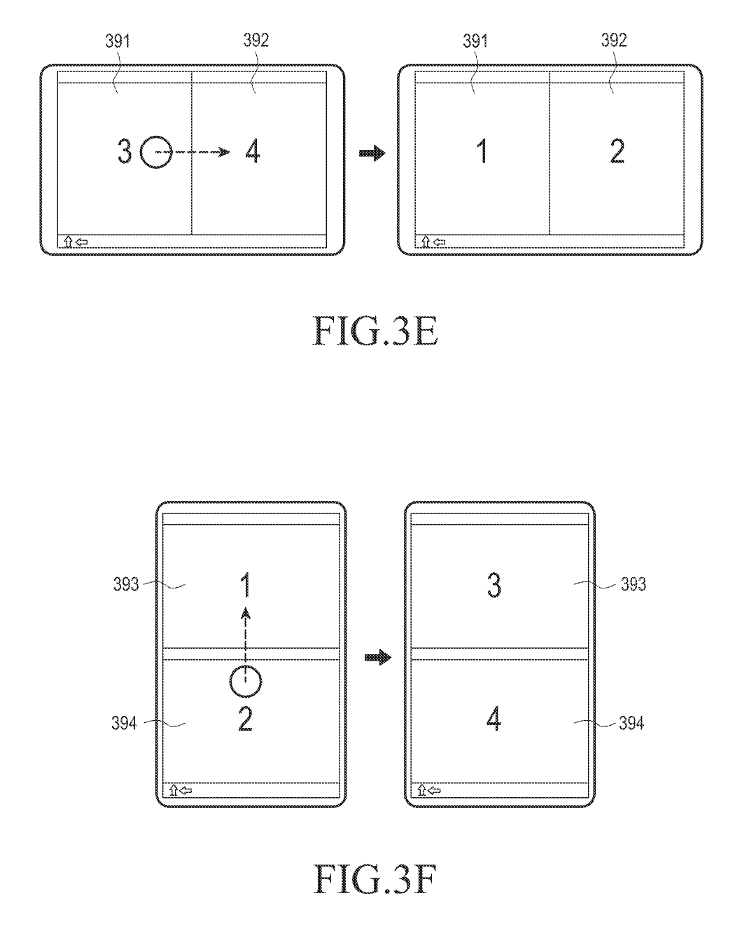

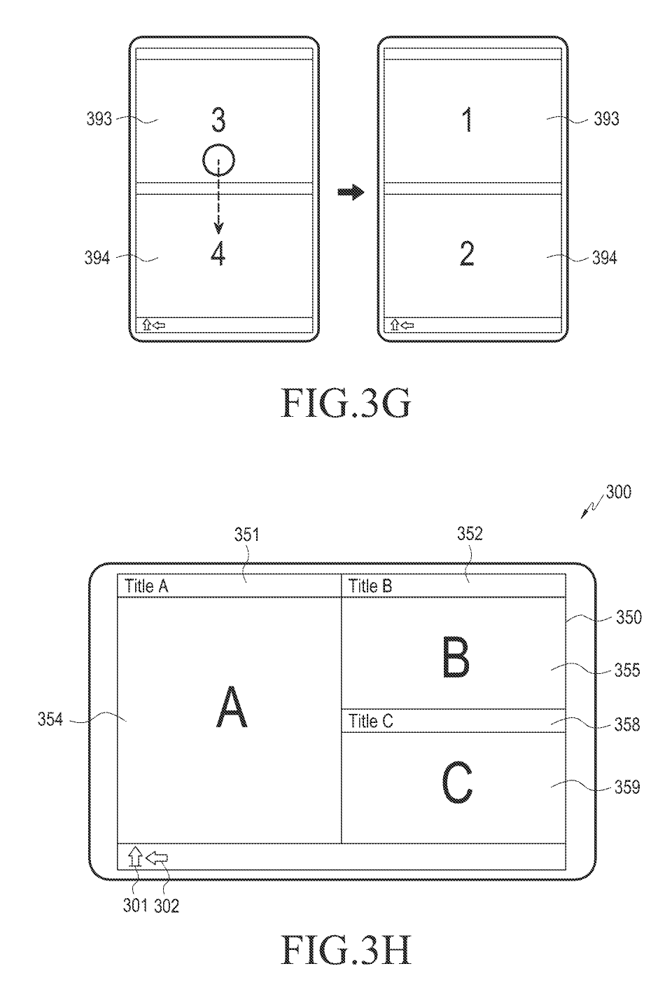

Referring to FIG. 2, a front face 100a of the apparatus may have the touch screen 190 arranged in the center. The touch screen 190 may be formed to occupy most of the front face 100a of the apparatus. On an edge of the front face 100a of the apparatus 100, there may be the first camera 151 and the illumination sensor 170a arranged. On the side 100b of the apparatus, there may be arranged, e.g., a power/reset button 160a, a volume button 161b, the speaker 163, a terrestrial DMB antenna 141a for receiving broadcasts, the microphone 162 (not shown in FIG. 3), the connector 165 (not shown in FIG. 3), or the like. In the back of the apparatus (not shown), there may be the second camera 152 (not shown in FIG. 3).

The touch screen 190 may include a main screen 210 and a menu key collection stack 220. In FIG. 2, the apparatus 100 and the touch screen 190 may be arranged to have respective horizontal lengths longer than respective vertical lengths. For example, the touch screen 190 may be arranged in a horizontal direction.

The main screen 210 may display one or more applications. In FIG. 2, the touch screen 190 shows an example of displaying a home screen. The home screen may be a first screen to be displayed on the touch screen 190 when the apparatus 100 is powered on. Many application run icons 212 stored in the apparatus 100 may be displayed in rows and columns on a home screen. The application run icons 212 may be formed as icons, buttons, texts, or the like. If one of the application run icons is activated (e.g.,touched), an application corresponding to the touched application run icon may be run and displayed on the main screen 210.

The menu key collection stack 220 may be elongated in a lower part of the touch screen 190 along the horizontal direction and may include standard function buttons 222 to 228. When touched, a home screen move button 222 may display a home screen on the main screen 210. For example, if the home screen move key 222 is touched while an application is run on the main screen 210, then the home screen shown in FIG. 2 may be displayed on the main screen 210. A back button 224, when touched, may display a screen that was displayed right before a current screen, or may end a most recently used application. A multi-view mode button 226 may display an application on the main screen 210 in a multi-view mode according to the present invention, when touched. A mode switch button 228, when touched, may convert and display one or more of a plurality of currently running applications on the main screen 210 between different modes. For example, when the mode switch button 228 is touched, switching may be conducted between an overlap mode in which the plurality of applications are displayed by overlapping each other and a split mode in which the plurality of applications are displayed separately in different areas in the main screen 210.

In an upper part of the touch screen 190, there may be formed an upper bar (not shown) in which to display statuses of the apparatus 100, such as a battery charging state, intensity of received signals, current time, etc.

The menu key collection stack 220 and the upper bar may not be displayed, depending on an Operating System (OS) of the apparatus 100 or applications run in the apparatus 100. When both the menu key collection stack 220 and the upper bar are not displayed on the touch screen 190, the main screen 210 may be formed in the entire area of the touch screen 190. The menu key collection stack 220 and the upper bar may be also displayed translucently on top of the main screen 210.

FIG. 3A is a conceptual diagram of an apparatus with a touch screen including first and second windows according to an exemplary embodiment of the present invention.

Referring to FIG. 3A, the apparatus 300 may include the touch screen 350. On the touch screen 350, as described above, there may be a variety of icons, multimedia, application run screens, or the like, displayed via rendering. The apparatus 300 may display first and second title bars 351 and 352, first and second application run screens 354 and 355, and menu keys 301 and 302 on the touch screen 350.

The first and second title bard 351 and 352 may each display a format of characters, numbers, symbols, or the like for identifying the first and second applications. The first and second title bars 351 and 352 may be implemented, e.g., in an elongated bar format in the horizontal direction, however, it will be readily appreciated that exemplary embodiments of the present invention are not limited thereto and there may be other means for identifying applications.

The first and second application run screens 354 and 355 may display respective independent running applications. The first and second application run screens 354 and 355 may have substantially rectangular forms, each of which may be arranged under the first and second title bars 351 and 352, respectively. The first and second application run screens 354 and 355 may display texts or multimedia based on application configuration.

The first title bar 351 and the first application run screen 354 together may be called the first window. The window may be a screen in which to display an application run screen corresponding to an application and its identity, and may include at least one view. The view, an independent display unit, may be an object that may provide a visual image. For example, the view for displaying a designated letter may include a text view displaying a letter designated from a code in advance, a resource, a file, an image view for displaying images of a web, or the like.

In an exemplary embodiment of the present invention, the apparatus 300 may display the first and second applications separately in the first window, or in both the first and second windows, or separately in the second window. In other words, running or stopping the first application may not affect the running or stopping of the second application. Accordingly, even if the first application is stopped, the second application may be displayed in the second window in steps 352 and 355. In another example, the second application may be displayed throughout the first and second windows.

The menu keys 301 and 302 may provide functions to manipulate general operations of the apparatus 300. For example, if the user touches the menu key 301, the apparatus 300 may provide a menu screen. If the user touches the menu key 302, the apparatus 300 may display back a screen that was displayed in a previous step. The manipulation by touching on the menu keys 301 and 302 is only illustrative, and it will be appreciated that there may be various implementations for manipulating the general operations of the apparatus 300 with a single manipulation of the menu key 301 or 302 or in combination of the menu keys 301 and 302. The menu keys 301 and 302 may have an elongated form in the horizontal direction of a part of the touch screen 350 of FIG. 3A, e.g., the first and second application run screens 354 and 355. The menu keys 301 and 302 may also be implemented in the form of physical buttons located at a distance from the touch screen 350 in other exemplary embodiments of the present invention.

FIG. 3B is a conceptual diagram of an apparatus with a touch screen including first and second windows according to an exemplary embodiment of the present invention.

Referring to FIG. 3B, which is in contrast to that illustrated in FIG. 3A, the first window 351 and 354 and the second window 352 and 355 may be arranged at a predetermined distance from each other. It will be appreciated by one of ordinary skill in the art that there may be different configurations to separate the first and second windows other than the example of FIG. 3B.

FIG. 3C is a conceptual diagram of an implementation according to an exemplary embodiment of the present invention.

Referring to FIG. 3C, first and second applications may be displayed like they are displayed on respective pages of a book. On the touch screen 350, the first title bar 351, the first application run screen 354, the second title bar 352, and the second application run screen 355 are displayed.

FIG. 3D is a conceptual diagram for explaining a change of a display screen by switching between running applications according to an exemplary embodiment of the present invention.

Referring to FIG. 3D, the first and second applications are displayed in the first and second windows 391 and 392, respectively.

The user may input a touch and flip gesture to the left after touching a point in the second window 392, and accordingly, the controller 110 may stop displaying the first and second applications and control to display third and fourth applications in the first and second windows 391 and 392, respectively. The touch and flip gesture may be to move a touch point toward a specified direction at relatively fast speed compared to a drag gesture after the touch point is touched, and then to release the touch mode. Additionally, a display change event for inputting the touch and flip gesture to the left after a touch point in the second window 392 may be touched in a fashion similar to an action to run an application that exists on the right side of the first and second applications, thus, tuning according to the user's intuition.

The controller 110 may detect and analyze a display change event. In FIG. 3D, the controller 110 may determine that a display change event is to run and display the application on the right side of the first and second applications in a specified order. The controller 110 may control the touch screen to display the third and fourth application run screens in the first and second windows 391 and 392, respectively. The third and fourth applications may be applications arranged on the right side of the first and second applications in a user-edited or defaulted specified order.

FIG. 3E is a conceptual diagram explaining a change of a display screen by switching between running applications according to an exemplary embodiment of the present invention.

Referring to FIG. 3E, the third and fourth applications are displayed in the first and second windows 391 and 392, respectively.

The user may input a touch and flip gesture to the right after touching a point in the first window 391, and accordingly, the controller 110 may stop displaying the third and fourth applications and control to display first and second applications in the first and second windows 391 and 392, respectively. The display change event for inputting the touch and flip gesture to the right after a point in the first window 391 is touched is similar to an action to run an application that exists on the left side of the third and fourth applications, thus tuning according to a user's intuition.

The controller 110 may detect and analyze a display change event. In FIG. 3E, the controller 110 may determine that a display change event is to run and display the application on the left side of the third and fourth applications in a specified order. The controller 110 may control the touch screen to display first and second application run screens in the first and second windows 391 and 392, respectively. The first and second applications may be applications arranged on the left side of the third and fourth applications in a user-edited or default specified order.

FIG. 3F is a conceptual diagram explaining a change of a display screen by switching between running applications according to an exemplary embodiment of the present invention.

Referring to FIG. 3F, the controller 110 controls the first and second applications to be displayed in the first and second windows 393 and 394, respectively. In the exemplary embodiment of the present invention of FIG. 3F, as opposed to that of FIG. 3D, first and second windows 393 and 394 may be displayed by arranging them in a vertical direction instead of a horizontal direction.

The user may input a touch and flip gesture in the upper direction after touching a point in the second window 394, and accordingly, the controller 110 may stop displaying the first and second applications and control to display third and fourth applications in the first and second windows 393 and 394, respectively. The display change event for inputting the touch and flip gesture in the upper direction after a touch point in the second window 394 may be touched in a fashion similar to an action to run an application that exists under the first and second applications, thus tuning according to the user's intuition.

The controller 110 may detect and analyze the display change event. In FIG. 3F, the controller 110 may determine that a display change event is to run and display the application under the first and second applications in a specified order. The controller 110 may control the touch screen to display third and fourth application run screens in the first and second windows 393 and 394, respectively. The third and fourth applications may be applications arranged under the first and second applications in a user-edited or default specified order.

FIG. 3G is a conceptual diagram explaining a change of a display screen by switching between running applications according to an exemplary embodiment of the present invention.

Referring to FIG. 3G, the third and fourth applications are displayed in the first and second windows 393 and 394, respectively.

The user may input a touch and flip gesture in the lower direction after touching a point in the first window 393, and accordingly the controller 110 may stop displaying the third and fourth applications and control to display first and second applications in the first and second windows 393 and 394, respectively. The display change event for inputting the touch and flip gesture in the lower direction after a point in the first window 393 may be touched in a fashion similar to an action to run an application that exists above the third and fourth applications, thus tuning according to a user's intuition.

The controller 110 may detect and analyze the display change event. In FIG. 3G, the controller 110 may determine that the display change event is to run and display the application above the third and fourth applications in a specified order. The controller 110 may control the touch screen to display first and second application run screens in the first and second windows 393 and 394, respectively. The first and second applications may be applications arranged above the third and fourth applications in a user-edited or default specified order. The specified order of the applications may be edited by the user, or may be, for example, the arrangement order of icons displayed on the background screen.

FIG. 3H is a conceptual diagram of an apparatus with a touch screen including first, second, and third windows according to an exemplary embodiment of the present invention.

Referring to FIG. 3H, on the touch screen 350, three windows are displayed. On the touch screen 350, there may be the first window 351 and 354, the second window 352 and 355, and a third window 358 and 359 displayed. The windows may include first, second, and third application display screens 354, 355, and 359 for displaying first, second, and third applications, respectively, and may include title bars 351, 352, and 358 for identifying the applications, respectively

FIG. 3I is a conceptual diagram of an apparatus with a touch screen including first and second windows according to an exemplary embodiment of the present invention.

Referring to FIG. 3I, two windows 381 and 382, and 383 and 384 are displayed on the touch screen 350. The windows 381 and 382, and 383 and 384 may be shown to be partially overlapped, as shown in FIG. 3I.

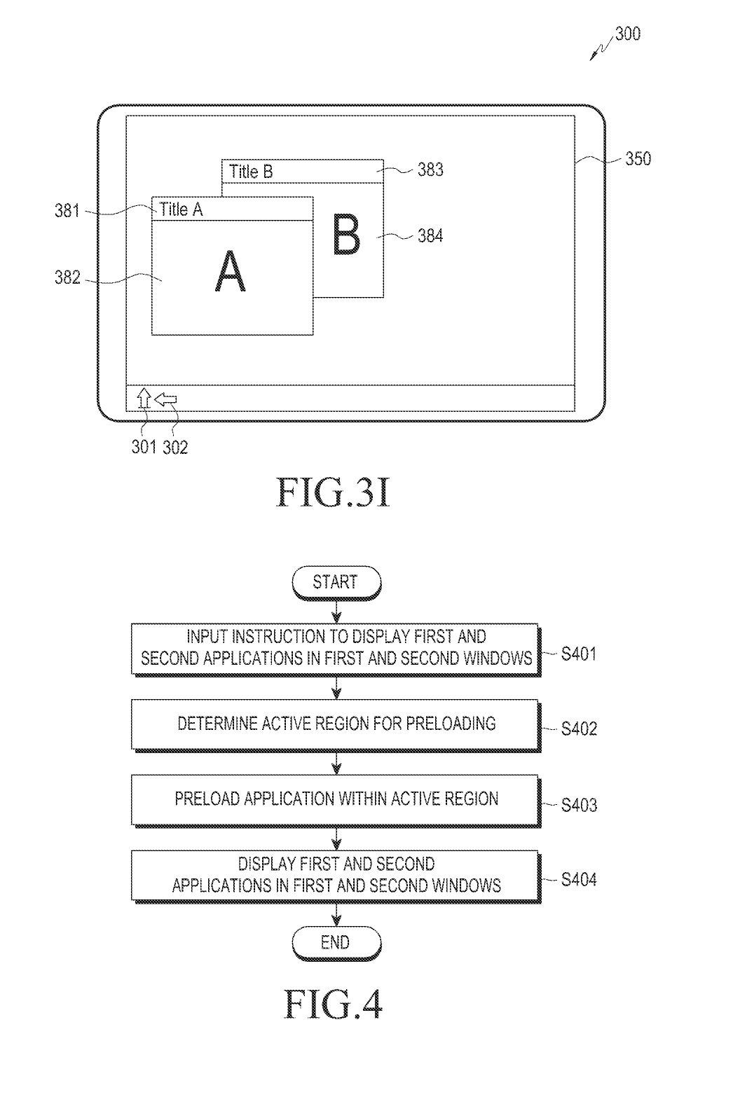

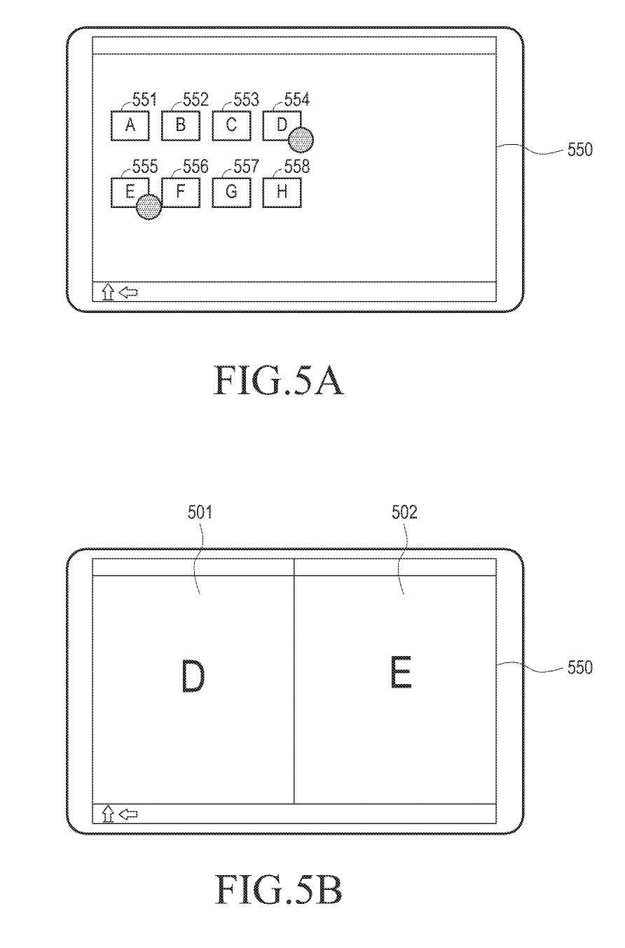

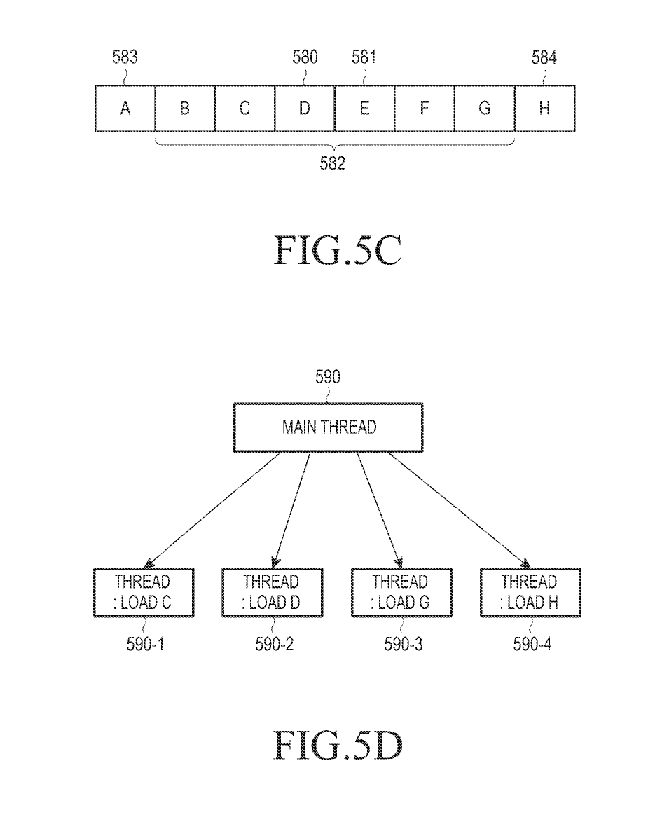

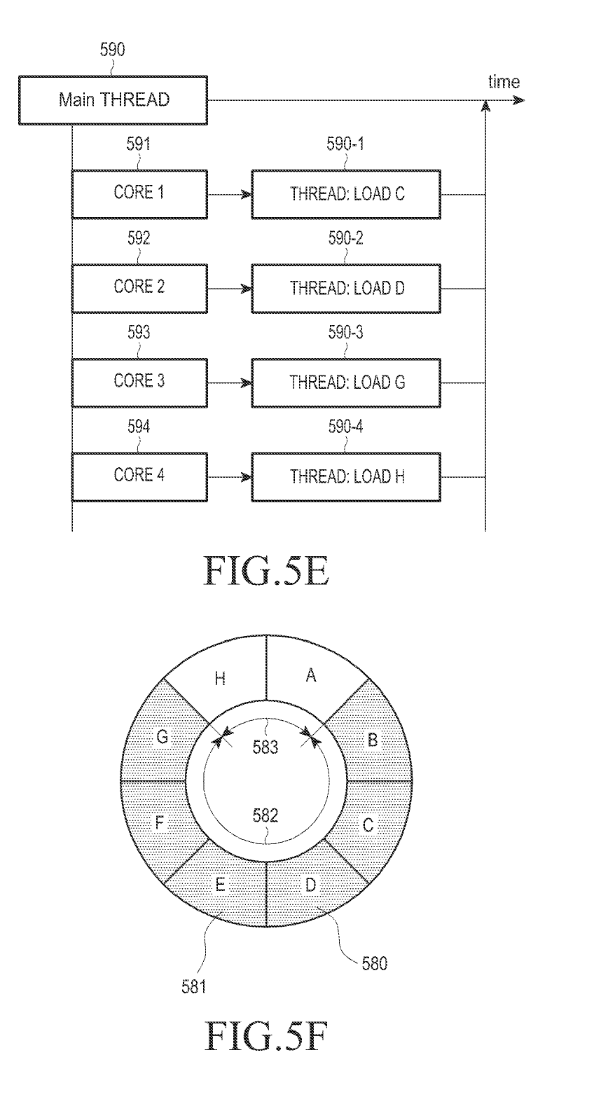

FIG. 4 is a flowchart of a method of controlling an apparatus with a touch screen for preloading a plurality of applications according to an exemplary embodiment of the present invention. The steps of FIG. 4 will now be described with reference to FIGS. 5A to 5F.

Referring to FIG. 4, the controller 110 may receive an instruction to display the first and second applications in the first and second windows, respectively, in step S401. In this regard, an instruction to run the first and second applications may, for example, be a touch on predetermined positions of the touch screen. However, it will be appreciated that displaying the first and second applications in the first and second windows by touching predetermined positions is only illustrative, and a variety of modifications, such as substantially simultaneous touching on two run icons may also display the first and second applications in the first and second windows, respectively.

FIGS. 5A and 5B are conceptual diagrams explaining receiving instructions to display first and second applications in the first and second windows, respectively according to an exemplary embodiment of the present invention.

Referring to FIG. 5A, a plurality of icons 551-558 to run the plurality of applications are displayed on the touch screen 550. The display change event for displaying applications D and E in the first and second windows, respectively, may be entered by substantially simultaneously touching icons 554 and 555 for applications D and E. The term “substantially simultaneously” means that a difference in time between when the two icons for the applications are touched is less than a predetermined threshold.

The controller 110 may determine, by analyzing the display change event, that a user's inputs are instructions to display applications D and E in the first and second windows, respectively. Accordingly, the controller 110 may control the touch screen 550 to display applications D and E in first and second windows 501 and 502, respectively.

After that, the controller 110 may determine an active region for preloading in step S402.

FIG. 5C is a conceptual diagram explaining a procedure of determining the active region for preloading according to an exemplary embodiment of the present invention.

Referring to FIG. 5C, a plurality of applications (A to H) may have a specified order. The specified order may be edited by the user, as described above, or may be an arrangement according to the order of icons displayed on the touch screen, as shown in FIG. 5A.

In the foregoing description, applications currently being displayed in the first and second windows are applications D and E 580 and 581. The controller 110 may determine an active window 582 for preloading by setting up a predetermined number (two in the present exemplary embodiment) of applications in the left and right directions with respect to the currently displayed application. The predetermined number, such as two, may be changeable. The more the predetermined number increases, the wider the active region for preloading is expanded, potentially followed by a waste of resources. Applications not included in the active region are called applications in a non-active region. The term “preloading” refers to loading an application to a predetermined stage, e.g., to an initial screen stage by calling the application to be preloaded into the RAM 111 or ROM 112 of the controller 110.

Here, among the applications to be preloaded, one adjacent to a displayed application may be preloaded first in time. Specifically, applications C and F adjacent to the displayed applications D and E 580 and 581 may be preloaded first and then applications B and G may be preloaded next. Applications A and H 583 and 584 may be in a non-active region.

FIGS. 5D and 5E are conceptual diagrams explaining a preloading method by dividing a main thread according to an exemplary embodiment of the present invention.

Referring to FIG. 5D, the controller 110 may divide the main thread 590 for applications to be preloaded into a predetermined number of split-threads 590-1, 590-2, 590-3, and 590-4, and control each of them to process each of the applications to be preloaded. For example, the split-thread 590-1 loads the application C, the split-thread 590-2 loads the application D, the split-thread 590-3 loads the application G, and the split-thread 590-4 loads an application H.

The controller 110 may control each of multi-cores 591, 592, 593, and 594, as shown in FIG. 5E, to perform each of the split-threads 590-1, 590-2, 590-3, and 590-4. Thus, the applications C, D, G, and H may be processed in parallel, which reduces time to perform the preloading.

The controller 110 may preload an application in the determined active region in step S403. In other words, the controller 110 may control the applications D and E to be displayed on the touch screen, and may load the applications B to G to a predetermined stage by calling them into the RAM 111 or ROM 112. Alternatively, the controller 110 may not perform any job regarding applications A and H, or may remove application A or H if application A or H is loaded into the ROM 112.

Additionally, the controller 110 may control applications D and E to be displayed on the touch screen, as described above. In FIG. 4, the step S404 of displaying the first and second applications in the first and second windows, respectively, is shown to be after step of S403 in which the application within the active region is preloaded. This is, however, only illustrative and it will be appreciated that step S404 may be performed in any step after step S401 in which the display change event is entered.

FIG. 5F is a conceptual diagram explaining determining an active and non-active regions according to an exemplary embodiment of the present invention.

Referring to FIG. 5F, applications may be ordered in a loop-type structure instead of the linear structure as shown in FIG. 5C. A plurality of applications may be prioritized in a clockwise direction, i.e., in an order of A, B, C, D, E, F, G, and H. Additionally, assuming that applications D and E are determined to be displayed on the touch screen in the exemplary embodiment of the present invention of FIG. 5F, two applications in a counter-clockwise direction, applications B and C, and two applications in a clockwise direction, applications F and G, may be determined together with applications D and E to be in the active region 581. Applications A and H are determined to be in the non-active region 583.

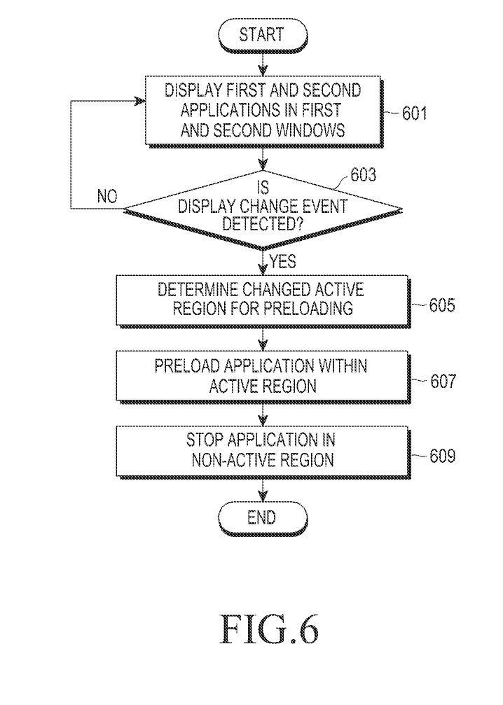

FIG. 6 is a flowchart of a method of controlling an apparatus with a touch screen for preloading the plurality of applications in switching between applications according to an exemplary embodiment of the present invention.

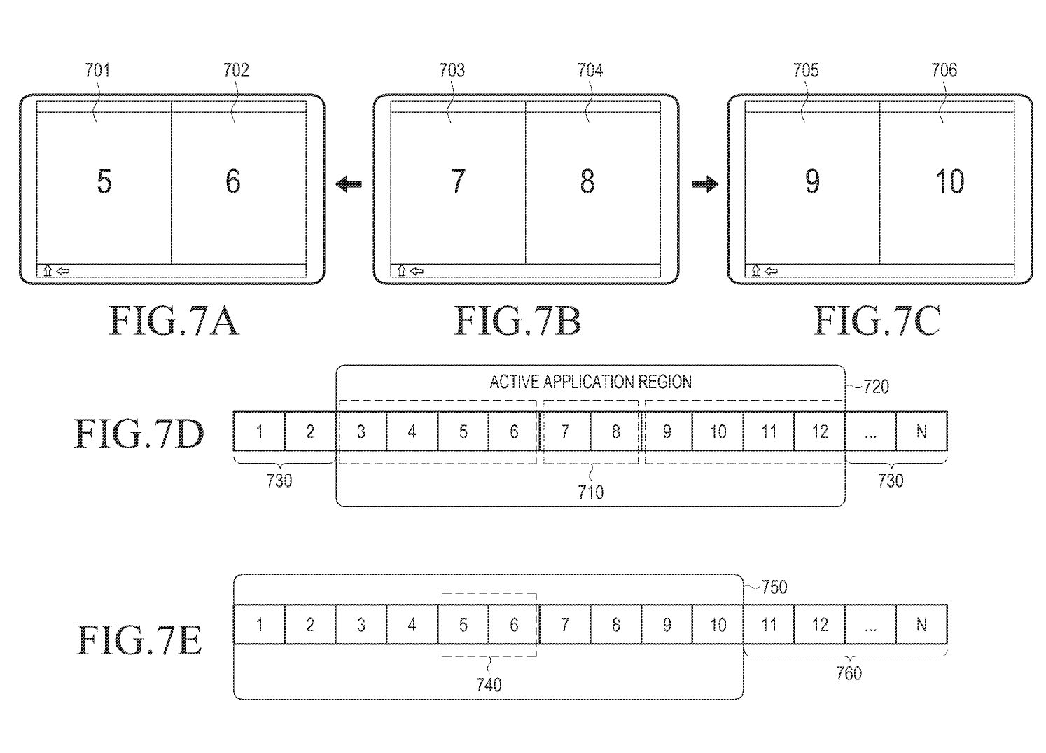

Referring to FIG. 6, the steps therein will now be described with reference to FIGS. 7A to 7E.

The controller 110 may receive an instruction to display the first and second applications in the first and second windows, respectively, and, in response, control the touch screen to display the first and second applications in the first and second windows, respectively, in step S601. For example, the display change event may correspond to a display of the 7^{th} and 8^{th} applications in the first and second windows, respectively. In response, the 7^{th} and 8^{th} applications may be displayed in the first and second windows 703 and 704, respectively, as shown in FIG. 7B. The controller 110 may determine the active and non-active regions at a time.

After that, the controller 110 may detect whether a display change event has been detected in step S603. The display change event may be a predetermined action to switch between applications displayed by the user, i.e., a touch and flip gesture as was explained above in connection with FIGS. 3D to 3G.

It will be appreciated that the touch and flip gesture is only illustrative, and it may be replaced by, e.g., an action of touching the second window, holding the touch until the first window is touched, and release the touch mode.

If no display change event is detected in step S603, the controller may control the touch screen 190 to keep displaying the first and second applications in the first and second windows, respectively.

If no display change event is detected in step S603, the controller may control the touch screen 190 to keep displaying the first and second applications in the first and second windows, respectively.

If a display change event is detected in step S603, the controller may determine to change the active region for preloading in step S605, preload one or more applications within the active region in step S607, and stop the application in the non-active region in step 609.

FIGS. 7A and 7C are conceptual diagrams explaining a change of an active region in switching between applications according to an exemplary embodiment of the present invention. The plurality of applications (e.g., 1^{st} to N^{th} applications), may be placed in a specified increasing order.

The user may input the display change event to display the 5^{th} and 6^{th} applications on the left side of the 7^{th} and 8^{th} applications. The display change event may be, e.g., a touch and flip gesture to the right after touching a point in the first window 703 of FIG. 7B. The controller 110 may analyze the display change event and then control the touch screen to run the 5^{th} and 6^{th} applications in the first and second windows 701 and 702, respectively, as shown in FIG. 7A. The controller 110 may determine the display change event based on the relationship between a previously stored display change event in the storage element 175 and a changed display screen.

The user may input the display change event to display the 9^{th} and 10^{th} applications on the right side of the 7^{th} and 8^{th} applications. The display change event may be, e.g., a touch and flip gesture to the left after touching a point in the second window 704 of FIG. 7B. The controller 110 may determine the display change event and then control the touch screen 190 to run the 9^{th} and 10^{th} applications in the first and second windows 705 and 706, respectively, as shown in FIG. 7C.

The controller 110 may also change the active region for preloading as the applications for display are changed.

FIGS. 7D and 7E are conceptual diagrams explaining a change of an active region in switching between applications according to an exemplary embodiment of the present invention. FIG. 7D is a conceptual diagram of the active region corresponding to FIG. 7B.

Referring to FIG. 7D, the 7^{th} and 8^{th} applications are determined to be applications 710 for display, and in addition to the 7^{th} and 8^{th} applications, four applications on the left side of the 7^{th} application, i.e., 3^{rd}, 4^{th}, 5^{th}, 6^{th} applications, and another four applications on the right side of the 8th application, i.e., 9^{th}, 10^{th}, 11^{th}, and 12^{th} applications, may be determined to be in the active region 720. Additionally, 1^{st} and 2^{nd} applications and 13^{th} to N^{th} applications may be determined to be in a non-active region 730.

FIG. 7E is a conceptual diagram of a changed active region that corresponds to FIG. 7A.

Referring to FIG. 7E, the 5^{th} and 6^{th} applications may be determined to be applications 740 for display, and in addition to the 5^{th} and 6^{th} applications, four applications on the left side of the 5^{th} application, i.e., 1^{st}, 2^{nd}, 3^{rd}, and 4^{th} applications, and another four applications on the right side of the 6^{th} application, i.e., 7^{th}, 8^{th}, 9^{th}, and 10^{th} applications, may be determined to be in the changed active region 750. The 11^{th} to N^{th} applications are determined to be in the non-active region 760.

The controller 110 may preload applications in the changed active region (e.g., 1^{st} to 10^{th} applications), in step S607. Specifically, the controller 110 may call the 1^{st} to 10^{th} applications into the RAM 112 or ROM 113 to load them to a predetermined stage, e.g., an initial stage.

Additionally, in response to the change of the active region, the controller 110 may stop or terminate running applications determined to be in the non-active region, e.g., the 11^{th} and 12^{th} applications of FIG. 7E. The controller 110 may delete the loaded 11^{th} and 12^{th} applications from the RAM 112 or ROM 113.

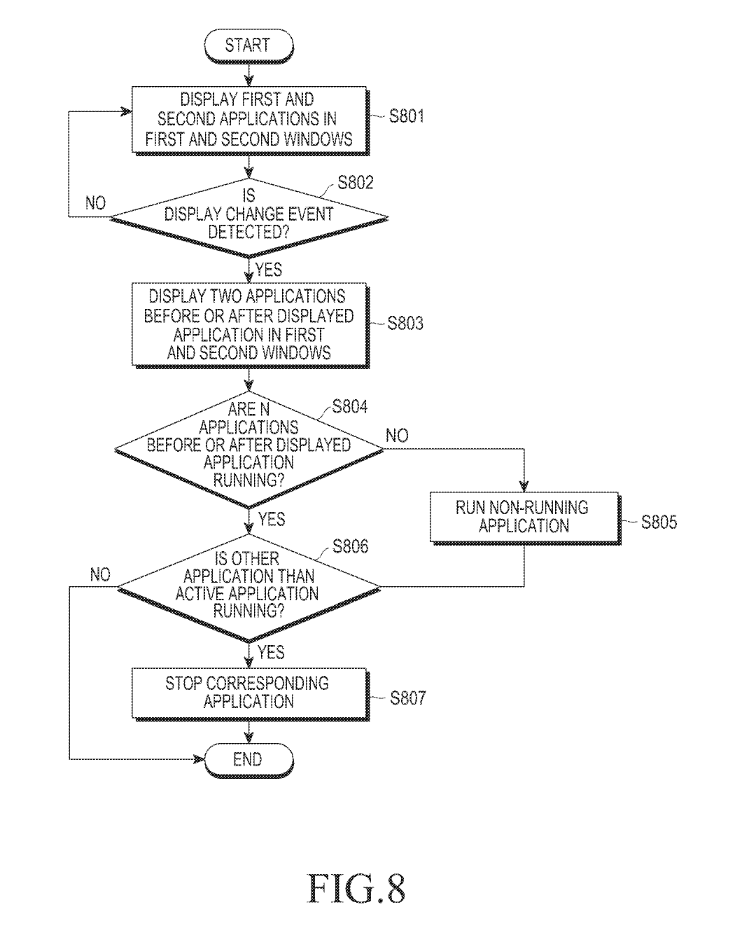

FIG. 8 is a flowchart of a method of controlling an apparatus with a touch screen for preloading a plurality of applications and switching between applications according to an exemplary embodiment of the present invention.

The controller 110 may receive an instruction to display the first and second applications in the first and second windows, respectively, and, in response, control the touch screen to display the first and second applications in the first and second windows, respectively, in step S801. The controller 110 may determine the active and non-active regions at a time.

The controller 110 may detect the display change event in step S802. If determining that the display change event is detected in step S802, the controller 110 may control the touch screen to display two applications before or after an application is displayed in the first and second windows, in step S803.

Additionally, the controller 110 may determine whether N applications before and after the changed application for display are running, i.e., preloaded, in step S804. If any applications in the active region are not running in step S804, the controller 110 may run an application not currently running in the active region in step S805.

Otherwise, if applications in the active region are running, in step S804, the controller 110 may determine whether applications in regions other than the active region, i.e., in the non-active region, are running in step S806. If the applications in the non-active region are running, in step S806, the controller 110 may stop or terminate the running applications in the non-active region, in step S807.

According to various exemplary embodiments of the present invention, an apparatus and method for splitting one touch screen to display respective applications is provided when running a plurality of applications. Additionally, an apparatus and method of establishing an active region among a plurality of applications, and preloading an application in the active region is provided, thus ensuring more expedient application running and/or switching.

While the present invention has been shown and described with reference to certain exemplary embodiments thereof, it will be understood by those skilled in the art that various changes in form and details may be made without departing from the spirit and scope of the present invention as defined by the appended claims and their equivalents.

What is claimed is:

1. An apparatus comprising:
a touch screen having a first window in which a first application is run and a second window in which a second application is run;
a storage element for storing a plurality of applications including the first and second applications, and preset information about an arrangement order in which the plurality of applications are placed; and
a controller for controlling the touch screen to display the first and second applications in the first and second windows, respectively, and determining a predetermined number of applications, with respect to the first and second applications, for preloading in an active region of the storage element from among the plurality of applications based on the preset information about the arrangement order.

2. The apparatus of claim 1, wherein the controller preloads an application included in the active region of the storage element.

3. The apparatus of claim 1, wherein the controller determines an application not included in the active region of the storage element from among the plurality of applications to be in a non-active region, and stops or terminates running of the application in the non-active region.

4. The apparatus of claim 1, wherein the controller detects whether a display change event for changing a screen display has occurred in at least one of the first and second windows.

5. The apparatus of claim 4, wherein the controller detects the display change event and controls the touch screen to display third and fourth applications in the first and second windows, respectively.

6. The apparatus of claim 5, wherein the controller determines a predetermined number of applications from among the plurality of applications, with respect to the third and fourth applications, based on the preset information about the arrangement order to be in a changed active region of the storage element.

7. The apparatus of claim 6, wherein the controller preloads an application included in the changed active region of the storage element.

8. The apparatus of claim 7, wherein the controller determines an application not included in the changed active region of the storage element from among the plurality of applications to be in a changed non-active region, and stops or terminates running of the application in the changed non-active region.

9. The apparatus of claim 5, wherein the display change event is at least one event selected from among a touch and flip gesture to the left after touching a point in the second window, a touch and flip gesture to the right after touching a point in the first window, and a drag gesture to hold a touch after touching a point in the second window and release the touch at a point in the first window, and
wherein the controller determines the third and fourth applications to be on the right side of the second application based on the information about the arrangement order if the display change event is the drag gesture or the touch and flip gesture to the left after touching the point in the second window or the drag gesture, and determines the third and fourth applications to be on the left side of the first application based on the information about the arrangement order if the display change event is the drag gesture or the touch and flip gesture to the right after touching the point in the first window.

10. A method of controlling an apparatus with a touch screen having a first window in which a first application is run and a second window in which a second application is run, the method comprising:
displaying the first and second applications in the first and second windows, respectively;
reading out preset information about an arrangement order in which a plurality of applications including the first and second applications are placed; and
based on the preset information about the arrangement order, and with respect to the first and second applications, determining a predetermined number of applications for preloading in an active region of the storage element from among the plurality of applications.

11. The method of claim 10, further comprising:
preloading an application included in the active region.

12. The method of claim 10, further comprising:
determining an application not included in the active region from among the plurality of applications to be in a non-active region; and
stopping or terminating the running of the application included in the non-active region.

13. The method of claim 10, further comprising:
determining whether a display change event for changing a screen display has occurred in at least one of the first and second windows.

14. The method of claim 13, further comprising:
analyzing the display change event and displaying third and fourth applications in the first and second windows, respectively.

15. The method of claim 14, further comprising:
determining, from among the plurality of applications, a predetermined number of applications with respect to the third and fourth applications based on the preset information about the arrangement order to be in a changed active region of the storage element.

16. The method of claim 15, further comprising:
preloading an application included in the changed active region.

17. The method of claim 16, further comprising:
determining an application not included in the changed active region of the storage element from among the plurality of applications to be in a changed non-active region; and
stopping or terminating running of the application included in the changed non-active region.

18. The method of claim 14, wherein the display change event is selected from among a touch and flip gesture to the left after touching a point in the second window, a touch and flip gesture to the right after touching a point in the first window, and a drag gesture to hold a touch after touching a point in the second window and release the touch at a point in the first window, and
wherein the displaying of the third and fourth applications comprises:
determining the third and fourth applications to be on the right side of the second application based on the preset information about the arrangement order if the display change event is the drag gesture or the touch and flip gesture to the left after touching the point in the second window or the drag gesture; and determining the third and fourth applications to be on the left side of the first application based on the information about the arrangement order if the display change event is the drag gesture or the touch and flip gesture to the right after touching the point in the first window.

19. An apparatus comprising:
a touch screen for displaying at least one window in which at least one display application is run;
a storage element for storing a plurality of applications including the at least one display application and preset information about an arrangement order in which the plurality of applications are placed; and
a controller for controlling the touch screen to display the at least one display application in the at least one window, and, from among the plurality of applications, determining a predetermined number of applications for preloading, with respect to the at least one display application, based on the preset information about the arrangement order to be in an active region of the storage element.

20. A method of controlling an apparatus including a touch screen for displaying at least one window in which at least one display application is run, the method comprising:
displaying the at least one display application in the at least one window;
reading out preset information about an arrangement order in which a plurality of applications including the at least one display application are placed; and
based on the preset information about the arrangement order, determining a predetermined number of applications for preloading in an active region of the storage element from among the plurality of applications, with respect to the at least one display application.
